(19) United States
(12) Patent Application Publication
(10) Pub. No.: US 2010/0259495 A1
(43) Pub. Date: Oct. 14, 2010

(54) INPUT DEVICE

(75) Inventors: Hiroshi Shigetaka, Fukushima-ken (JP); Sadakazu Shiga, Fukushima-ken (JP); Katsumi Kato, Fukushima-ken (JP)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: ALPS ELECTRIC CO., LTD, Tokyo (JP)

(21) Appl. No.: 12/754,202

(22) Filed: Apr. 5, 2010

(30) Foreign Application Priority Data
Apr. 9, 2009 (JP) 2009-094461

(51) Int. Cl. G06F 3/041

(52) U.S. Cl. 345/173; 178/18.03

(57) ABSTRACT

An input device includes a coordinate input member which has a predetermined area and detects a position touched with an indicator, and a detection member which detects that the coordinate input member has been pressed.

### CROSS-REFERENCE TO RELATED APPLICATION

The present invention contains subject matter related to and claims the benefit of Japanese Patent Application No. JP 2009-094461 filed in the Japanese Patent Office on Apr. 9, 2009, the entire contents of which is incorporated herein by reference.

### BACKGROUND OF THE DISCLOSURE

1. Technical Field

The present invention relates to an input device which is mounted on a personal computer or the like, is capable of detecting a coordinate position which has been touched with an indicator such as a finger, and is capable of detecting an operation when pressed with a finger or the like.

2. Related Art

An operation portion of a laptop personal computer is provided with a keyboard device having a plurality of arranged key tops. A coordinate input device for inputting coordinate data with a finger may be provided on the front side of the keyboard device, and two press buttons may be provided on the front side of the coordinate input device. The coordinate input device may be provided with a plurality of X electrodes and a plurality of Y electrodes which are insulated from each other. The coordinate input device detects variation in capacitance between electrodes when a user's finger which is a conductor touches an operation face, and an input signal equivalent to an input signal of a mouse is normally generated. The two press buttons provided on the front side of the coordinate input device may be a right click button and a left click button. When the press button is pressed, a click signal corresponding to the pressing of a right click button or a left click button provided on a mouse is normally generated.

Recently, laptop personal computers and the like have been made thin and small. Accordingly, it is getting difficult to install a keyboard device, a coordinate input device, and two press buttons on the operation portion in consideration of space. Thus, there is a problem that the operation face of the coordinate input device becomes smaller since the two press buttons are provided, and it is difficult to operate the coordinate input device with a finger.

In the invention described in Japanese Unexamined Patent Application Publication No. 2002-123363, an operation portion of a mobile electronic apparatus is provided with a capacitance input device, and key input portions are displayed on an input face thereof. When the input face is operated by a finger, which key input portion is touched with the finger is recognized and key input data is generated. The input face can be also used as an input portion of coordinate data. That is, it is possible to perform both the key input and the coordinate input by the common coordinate input device.

In the case of a coordinate input device provided on a personal computer, an operation of inputting coordinate data by moving a finger on an operation face and an operation of pressing a right click button or a left click button are frequently and repeatedly performed. Accordingly, it is difficult to analyze detection data and to distinguish and recognize the input of the coordinate data and the key input on the common coordinate input device. For this reason, it is essential to separately provide the right click button and the left click button, in addition to the coordinate input device.

These and other drawbacks exist

### SUMMARY OF THE DISCLOSURE

An advantage of various embodiments is to provide an input device which is capable of generating a switch signal by operating an operation face of a coordinate input member which detects variation in capacitance, and is capable of performing both coordinate data input and switch input.

According to one example, an input device including a coordinate input member having a predetermined area and which detects a position touched with an indicator, and a detection member which detects that the coordinate input member has been pressed is provided.

In such an example, when the input face of the coordinate input device is touched with an indicator such as a finger, the touched position is detected, coordinate data is generated, the input face is directly pressed by the indicator, the detection member is operated, and then switch data which is separate from the coordinate data is generated.

Also, the coordinate input member may have a detection sheet detecting a position where the conductive indicator has been moved closer on the basis of variation in capacitance, a rigid substrate supporting the detection sheet, and a support member supporting the coordinate input member so that it can be moved in a thickness direction thereof, and the detection member may be operated when the coordinate input member is pressed against force of a pressing member.

In the input device, a part of the coordinate input member may be a movable portion that is movable in the thickness direction, and the detection member may be operated when the movable portion is pressed.

The coordinate input member may have a detection sheet detecting a position where the conductive indicator has been moved closer on the basis of variation in capacitance and a reinforcement plate overlapping with the detection sheet, and a part of the reinforcement plate may be movable in the thickness direction at the movable portion.

The coordinate input member may also have a detection sheet detecting a position where the conductive indicator has been moved closer on the basis of variation in capacitance, a part of the detection sheet may be flexible and deformable in the thickness direction at the movable portion, and the detection member may be operated when a part of the detection sheet is pressed.

Since the movable portion that is a part of the coordinate input member is pressed to operate the detection member, it is easy to distinguish and perform the operation of the coordinate input and the operation of the press button input, as operations with different feelings. Since the coordinate data and the switch data as input signals can be output as distinguished data, a main body receiving the input signals easily performs the process operation.

In various examples, two movable portions may be provided. In this case, one movable portion may be used as an input portion equivalent to a right click button, and the other movable portion may be used as an input portion equivalent to a left click button.

In these examples, the detection member may be a press switch. A piezoelectric element, which generates a voltage when the piezoelectric element is pressed, may be used as the detection member, and the detection member may generate a detection signal and react to the coordinate input member when the detection member is pressed by the coordinate input member.

According to the various embodiments, it is possible to perform the coordinate input by touching the input face of the coordinate input member with the indicator such as a finger, and it is possible to perform the switch input by pressing the same input face. Accordingly, it is not necessary to provide a press button different from the input face of the coordinate input device, and it is easy to mount the coordinate input member on the small-size operation portion, together with the keyboard device and the like. In the small-size operation unit, it is possible to dispose the coordinate input member having a wide-area input face.

### BRIEF DESCRIPTION OF THE DRAWINGS

FIG. 1A is a plan view illustrating an input face of an input device according to an embodiment of the disclosure.

FIG. 1B is a front view illustrating a relationship of a coordinate input device and a detection member.

FIG. 2A is a plan view illustrating an input face of an input device according to an embodiment of the disclosure.

FIG. 2B is a front view illustrating a relationship of a coordinate input device and a detection member formed of a piezoelectric element.

FIG. 3A is a plan view illustrating an input face of an input device according to an embodiment of the disclosure.

FIG. 3B is a front view illustrating a relationship of a movable portion of a coordinate input device and a detection member.

FIG. 4A is a plan view illustrating an input face of an input device according to an embodiment of the disclosure.

FIG. 4B is a front view illustrating a relationship of a movable portion of a coordinate input device and a detection member.

### DETAILED DESCRIPTION OF EXEMPLARY EMBODIMENTS

The following description is intended to convey a thorough understanding of the embodiments described by providing a number of specific embodiments and details involving input devices. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

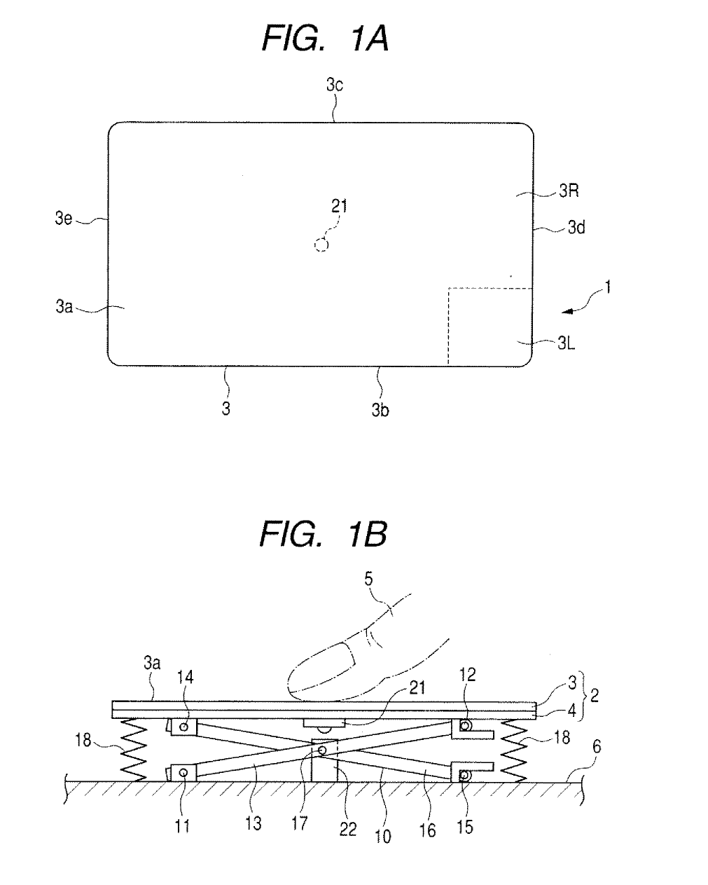

An input device 1 according to an embodiment shown in FIG. 1A and FIG. 1B is provided on the front side of a keyboard device in an operation portion of a laptop personal computer.

The input device 1 may have a coordinate input member 2. The coordinate input member 2 may have a detection sheet 3 and a rigid substrate 4 supporting the detection sheet 3 from the backside thereof.

The detection sheet 3 may have a plurality of X electrodes arranged parallel to each other, a plurality of Y electrodes arranged parallel to each other in a direction perpendicular to the X electrodes, and a plurality of detection electrodes provided parallel to the X electrodes or the Y electrodes. The X electrode, Y electrodes, and detection electrodes may be formed on a surface of a substrate formed of a flexible resin sheet, for example, so as to be insulated from each other. The uppermost surface of the detection sheet 3 may be an insulating layer, and the surface of the insulating layer may be a flat input face 3a.

An integrated circuit (IC) chip having a drive circuit and a detection circuit may be mounted on the back side of the rigid substrate 4. Pulse voltages with a rectangular waveform may be sequentially applied to the plurality of X electrodes, and pulse voltages with a rectangular waveform may be sequentially applied to the plurality of Y electrodes at timing different from the timing of applying the pulse voltages to the X electrodes. When a pulse voltage is applied to any X electrode and a finger 5 which is a conductive indicator has been moved closer the X electrode, capacitance may be formed between the X electrode and the finger 5. Accordingly, an electric current flowing from the X electrode to an adjacent detection electrode may be decreased as compared with a case where the finger 5 has not been moved closer. Therefore, the detection circuit may detect variation in current flowing in the detection electrode, and may identify which X electrode the voltage is applied to, thereby specifying an X coordinate of the position where the input face 3a is touched with the finger 5.

Similarly, the detection circuit may detect variation in current flowing in the detection electrode, and may identify which Y electrode the voltage is applied to, thereby specifying a Y coordinate of the position where the input face 3a is touched with the finger 5.

The rigid substrate 4 may be a glass substrate, an epoxy substrate, or the like, and may have sufficient rigidity so that it is not deformed by the pressing force of the finger 5.

As shown in FIG. 15, the coordinate input member 2 may be supported to a body base 6 of an electronic apparatus through support mechanisms 10. The support mechanisms 10 may be provided in two sets, one support mechanism 10 may support an inner part of a front edge 3b of the coordinate input member 2, and the other support mechanism 10 may support an inner part of a back edge 3c of the coordinate input member 2.

The support mechanism 10 may have two link members 13 and 16, and a center portion of the link member 13 and a center portion of the link member 16 may be rotatably connected to each other by a fulcrum shaft 17, for example. One end 11 of the link member 13 may be rotatably supported to the body base 6, and the other end 12 of the link member 13 may be slidable on a lower face of the rigid substrate 4 in a right direction and may be rotatably supported. One end 14 of the link member 16 may be rotatably supported to the lower face of the rigid substrate 4, and the other end 15 of the link member 16 may be slidable on an upper face of the body base 6 in the right direction and may be rotatably supported.

Since the rigid substrate 4 may be supported by the two sets of support mechanisms 10, the coordinate input member 2 may be movable in a direction away from and a direction approaching the body base 6 with the input face 3a kept in a horizontal posture. A compression coil spring 18 which may be a pressing member is interposed between the body base 6 and the rigid substrate 4, and the coordinate input member 2 may be pressed in a direction away from the body base 6 by elastic force of the compression coil spring 18.

As shown in FIG. 1B, a press switch 21 which may be a detection member may be provided under the rigid substrate 4, and the body base 6 may be provided with a press member 22 opposed to the press switch 21 so as to protrude upward. As shown in FIG. 1A, the press switch 21 and the press member 22 may be positioned at the center of the rectangular input face 3a of the coordinate input member 2. The rigid substrate 4 may be provided with the press member 22, and the body base 6 may be provided with the press switch 21.

When the input face 3a of the coordinate input member 2 is touched with the finger 5 with a relatively light force, the position touched with the finger 5 may be detected as a position on X-Y coordinates by a detection operation of the detection sheet 3. When the finger 5 which has touched the input face 3a may be moved, the movement direction and the movement distance may be detected. When the detection output about the coordinate position detected by the detection sheet 3 is transmitted to driver software installed in a computer, input data may be normally generated equivalent to an operation of a mouse and the input data may be transmitted to an operating system. By this operation, it may be possible to perform inputs such as movement of a cursor displayed on the screen, selection of a menu, and writing of text with manuscript input.

When the coordinate input member 2 is strongly pressed by the finger 5 touching the input face 3a, the coordinate input member 2 may be descended, the press switch 21 may be turned on, and the switch signal may be transmitted to the driver software. When the driver software receives the switch signal, the driver software may determine a position of the input face 3a touched with the finger 5 on the basis of the detection signal transmitted from the detection sheet 3. When the position touched with the finger 5 is determined as a preset right click area 3R, a right click signal may be generated equivalent to a case of pressing a right click button of a mouse by the driver software and may be transmitted to the operating system. When the switch signal is received with a left click area 3L touched with the finger 5 and the detection is performed, a left click signal may be generated equivalent to a case of pressing a left click button of a mouse by the driver software and may be transmitted to the operating system.

When the right click signal and the left click signal are transmitted, various process operations assigned in advance may be performed such as determination of a menu and determination of a movement range.

In the example shown in FIG. 1A, the right click area 3R which may have a relatively high frequency of use may be set in a range wider than the left click area 3L which may have a low frequency of use. The position and size of the right click area 3R and the left click area 3L may be freely set by changing the settings of the driver software by using a control panel of the computer. For example, the left click area 3L may be set at a left end of the input face 3a in a narrow area, or a right half of the input face 3a may be set as the right click area 3R and a left half may be set as the left click area. Also, the right click area may be set at a band-shaped part of the input face 3a taken along the right edge 3d, and the left click area may be set at a band-shaped part taken along the left edge 3e.

As described above, by setting the right click area 3R and the left click area 3L on the input face 3a, it may be possible to perform the input of the right click button and the input of the left click button by strongly pressing the input face 3a with the finger 5 in the course of performing the same operation as the normal mouse input with the input face 3a touched with the finger 5. Accordingly, even when two press buttons are not provided in an area other than the input face 3a, it may be possible to distinguish and perform the input of the coordinate data and the input of two click signals.

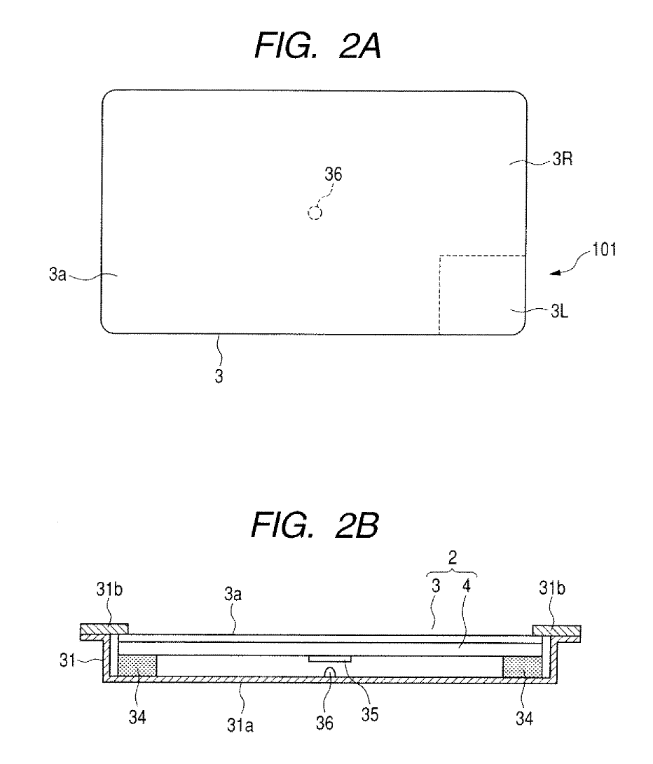

In an input device 101 according to an embodiment as shown in FIG. 2A and FIG. 2B, a coordinate input member 2 in which a detection sheet 3 and a rigid substrate 4 can be overlapped with each other may be housed in a relatively thin case 31. In the case 31, an elastic member 34 such as rubber and a thin plate spring may be interposed between a bottom 31a of the case 31 and the rigid substrate 4, and the coordinate input member 2 is pressed in a direction away from the bottom 31a by the pressing force of the elastic member 34. A stopper frame 31b may be provided on a front side of the case 31 to prevent the coordinate input member 2 from jumping forward.

A piezoelectric element 35 may be provided as a detection member on a lower face of the rigid substrate 4 of the coordinate input member 2, and a press protrusion 36 opposed to the piezoelectric element 35 may be provided on the bottom 31a of the case 31. As shown in FIG. 2A, the piezoelectric element 35 and the press protrusion 36 may be positioned at the center of the input face 3a. The piezoelectric element 35 may be provided on the bottom 31a of the case 31, and the press protrusion 36 may be provided under the rigid substrate 4.

The input device 101 shown in FIG. 2A and FIG. 2B can perform the input of coordinate data by touching the input face 3a with the finger 5 and moving the finger 5. In this case, the driver software generates data equivalent to input data of a mouse, and the data may be transmitted to the operating system.

When the input face 3a is pressed by the finger 5, the piezoelectric element 35 may abut against the press protrusion 36, distortion may be applied to the piezoelectric element 35 and voltage may be generated in the piezoelectric element 35. When a detection circuit in an IC chip mounted on a lower face of the rigid substrate 4 detects the voltage, a switch signal may be transmitted to the driver software. When the driver software determines that the right click area 3R of the input face 3a is touched with the finger 5, the driver software may generate a right click signal. When the driver software determines that the left click area 3L is touched with the finger 5, the driver software may generate a left click signal.

The position and size of the right click area 3R and the left click area 3L may be arbitrarily set in the same manner as the input device 1 shown in FIG. 1A and FIG. 1B.

The input face 3a is pressed by the finger 5, the piezoelectric element 35 may abut against the press protrusion 36, and the switch signal may be obtained. At this time, electric current may flow from a drive circuit to the piezoelectric element 35, distortion may be generated in the piezoelectric element 35, and a feedback feeling may be transferred from the input face 3a to the finger 5. For example, it is possible to apply repulsion vibration to the finger 5 pressing the input face 3a by applying a plurality of pulses of short-periodical pulse voltage to the piezoelectric element 35 for a short time.

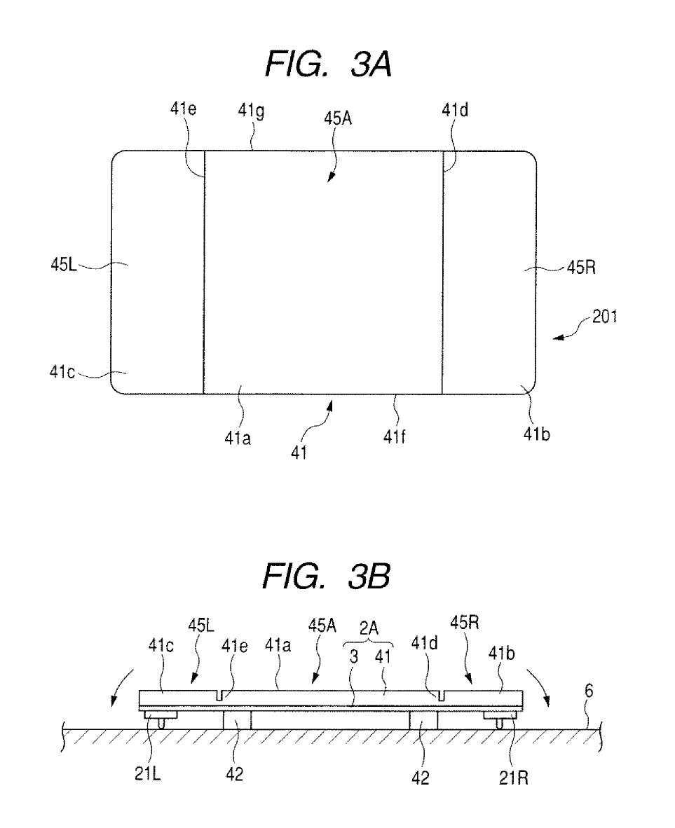

In an input device 201 according to a an embodiment as shown in FIG. 3A and FIG. 3B, a coordinate input member 2A may include a detection sheet 3 capable of detecting a coordinate position with variation in capacitance, and a cover plate 41 overlapping a surface of the detection sheet 3 and functioning as a reinforcement plate. The cover plate 41 may be partitioned into a center fixed portion 41a, a right movable portion 41b, and a left movable portion 41c. A notch may be formed, which may reach the middle of the thickness of the cover plate 41, at a boundary portion 41d between the center fixed portion 41a and the right movable portion 41b, thereby forming a hinge portion. Similarly, a notch may be formed, which may reach the middle of the thickness of the cover plate 41, at a boundary portion 41e between the center fixed portion 41a and the left movable portion 41c, thereby forming a hinge portion.

The boundary portion 41d and the boundary portion 41e may linearly extend from a front edge portion 41f of the cover plate 41 toward a back edge portion 41g, and the boundary portion 41d and the boundary portion 41e may be formed parallel to each other. An input face on the surface of the center fixed portion 41a may be a relatively wide center input area 45A. An input face on the surface of the right movable portion 41b may have a relatively narrow area, and may be a right click area 45R. An input face on the surface of the left movable portion 41c may have a relatively narrow area, and may be a left click area 45L.

As shown in FIG. 35, the center fixed portion 41a of the coordinate input member 2A may be fixed so as to be stationary on fixing members 42 and 42 provided on a body base 6. The right movable portion 41b may be movable downward with respect to the boundary portion 41d as a hinge, and may be provided with a right click switch 21R which may be a detection member on the back side of the right movable portion 41b. The left movable portion 41c may be movable downward with respect to the boundary portion 41e as a hinge, and may be provided with a left click switch 21L which may be a detection member on the back side of the left movable portion 41c.

The cover plate 41 may be formed of an insulating material with a predetermined dielectric constant, and may be formed to be thin but still able to specify a position on the surface of the cover plate 41 touched with the finger 5 by using the detection sheet 3.

The whole area of the center input area 45A, the light click area 45R, and the left click area 45L of the input device 201 may be a coordinate detection area where a position touched with the finger 5 can be detected by the detection sheet 3. When any one of the center input area 45A, the light click area 45R, and the left click area 45L is touched with the finger 5 and the finger 5 is moved, position data may be generated on coordinates with respect to the whole area as a target and may be transmitted to the driver software. The input data equivalent to that of a mouse, for example, may be transmitted from the driver software to the operating system on the basis of the position data.

When the right click area 45R is pressed by the finger 5, the right movable portion 41b may be moved to operate the right click switch 21R. When the left click area 45L is pressed, the left movable portion 41c may be moved to operate the left click switch 21L. When the right click switch 21R is operated, a right click signal may be generated by the driver software and may be transmitted to the operating system. When the left click switch 21L is operated, a left click signal may be generated by the driver software and may be transmitted to the operating system.

The input device 201 shown in FIG. 3A and FIG. 3B may output the coordinate data detected on the basis of the variation in capacitance in the detection sheet 3, and the switch signals generated by pressing the right click switch 21R and the left click switch 21L, as different signals. Accordingly, it may be easy to distinguish the coordinate input signal and the switch signal by using the driver software.

The cover plate 41 may be thoroughly separated into the center fixed portion 41a, the right movable portion 41b, and the left movable portion 41c, and the elastic force of the detection sheet 3 may be used as a hinge in the boundary portions 41d and 41e. The surfaces of the center fixed portion 41a, the right movable portion 41b, and the left movable portion 41c may be covered with a flexible thin sheet such that the grooves are not appear on the surfaces in the boundary portions 41d and 41e. The center fixed portion 41a may be formed to have a different thickness from the right movable portion 41b and the left movable portion 41c so as to form difference in level in the boundary portions 41d and 41e such that it may be possible to identify that any area is touched with the finger 5 with a feeling of the finger 5.

The right click switch 21R and the left click switch 21L may be provided on the body base 6 side. Piezoelectric elements may be provided instead of the right click switch 21R and the left click switch 21L. In this case, when the right movable portion 41b or the left movable portion 41c is pressed, distortion may be generated in the piezoelectric element, voltage may be output, and a switch signal may be generated. In this case, when the right movable portion 41b or the left movable portion 41c is pressed, electric current may flow in the piezoelectric element and operation reactive force may be applied to the finger 5.

A distance of moving the right movable portion 41b and the left movable portion 41c in a direction of the body base 6 may be set to the shortest length necessary for operating the right click switch 21R and the left click switch 21L. A restriction member for preventing the right movable portion 41b and the left movable portion 41c from considerably moving forward from the body base 6 may be provided.

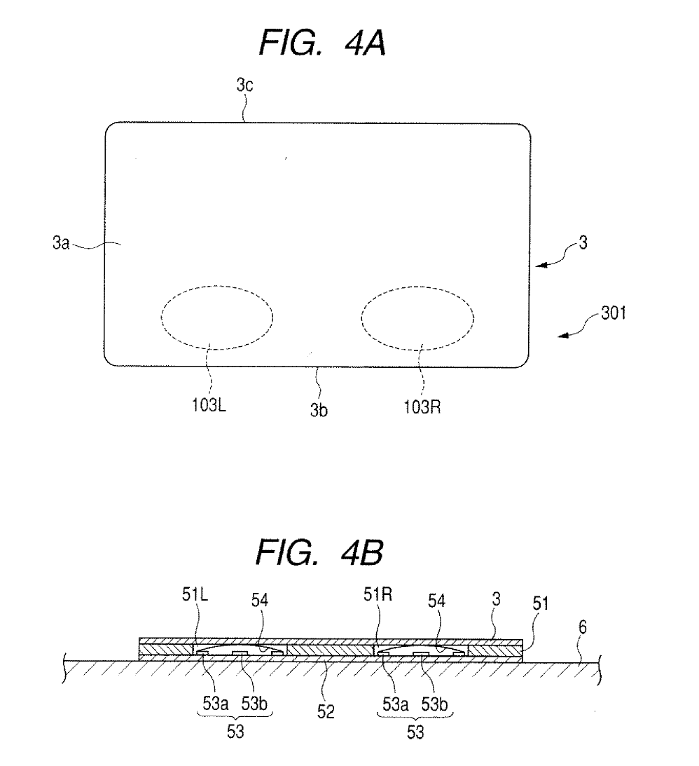

In an input device 301 shown in FIG. 4A and FIG. 4B, a coordinate input member may be formed of a flexible detection sheet 3. A flexible cover sheet may be further laminated on the surface of the detection sheet 3. Parts of an input face 3a on the surface of the detection sheet 3 may be a right click area 103R and a left click area 103L. The right click area 103R and the left click area 103L may be provided on the right and left at positions close to the front edge 3b of the detection sheet 3 with a gap between.

As shown in FIG. 48, the detection sheet 3 may be supported from the downside by a support member 51. In the support member 51, an operation space 51R may be formed under the right click area 103R, and an operation space 51L may be formed under the left click area 103L. The detection sheet 3 can be bent downward in the right click area 103R and the left click area 103L, and the other area may be fixed to the surface of the support member 51 and may have a inflexible structure.

Switch mechanisms may be housed in the operation space 51R and the operation space 51L. The switch mechanism in the operation space 51R may be a right click switch, and the switch mechanism in the operation space 51L may be a left click switch. The switch mechanism may have a fixed contact point 53 formed on a substrate 52 opposed to the downside of the detection sheet 3. The fixed contact point 53 may include a ring-shaped outer contact point 53a and an inner contact point 53b therein. A dome-shaped movable contact point 54 which may be formed of a conductive plate spring may be provided above the fixed contact point 53. A circumferential portion of the movable contact point 54 may be in contact with the outer contact point 53a, and an apex portion may be opposed to the inner contact point 53b.

The input device 301 shown in FIG. 4A and FIG. 4B can detect a coordinate position touched with the finger 5 using the whole area of the input face 3a on the surface of the detection sheet 3. Accordingly, it may be possible to obtain coordinate data equivalent to a mouse signal. When the right click area 103R is pressed by the finger 5, the pressed part of the detection sheet 3 may be bent, the movable contact point 54 underneath may be reversed so as to come into contact with the inner contact point 53b, and the outer contact point 53a may be electrically connected to the inner contact point 53b, thereby obtaining a switch signal. At this time, a right click signal may be generated by the driver software. When the left click area 103L is pressed by the finger 5, the switch mechanism thereunder may be operated to obtain a left click signal.

The detection members provided in the operation space 51R and the operation space 51L may be piezoelectric elements. The right click area 103R and the left click area 103L on the input face 3a may be painted with a color different from that of the other area, or the areas may be recessed or projected, thereby easily distinguishable from the other area.

The coordinate detection members provided in the input device 1 shown in FIG. 1A and FIG. 1B and the input device 101 shown in FIG. 2A and FIG. 2B may not by limited to the detection sheet 3 detecting the variation in capacitance, and may be a pressing-type input pad. In the pressing-type input pad, a flexible sheet may be opposed to a substrate, and resistive layers or an electrode layers are formed on the opposed faces of the substrate and the flexible sheet. When the sheet is pressed by the finger, the sheet may be bent, the resistive layers or the electrode layers come into contact with each other, and a coordinate position of the contact position may be detected.

It should be understood by those skilled in the art that various modifications, combinations, sub-combinations and alterations may occur depending on design requirements and other factors insofar as they are within the scope of the appended claims of the equivalents thereof.

Accordingly, the embodiments of the present inventions are not to be limited in scope by the specific embodiments described herein. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. An input device comprising:
a coordinate input member which has a predetermined area and detects a position touched with an indicator; and
a detection member which detects that the coordinate input member has been pressed.

2. The input device according to claim 1, wherein the coordinate input member has a detection sheet which detects a position where the conductive indicator has been moved closer on the basis of variation in capacitance, a rigid substrate supporting the detection sheet, and a support member supporting the coordinate input member so that it the coordinate input member is movable in a thickness direction thereof, and the detection member is operated when the coordinate input member is pressed against force of a pressing member.

3. The input device according to claim 1, wherein a portion of the coordinate input member is a movable portion that is movable in the thickness direction, and the detection member is operated when the movable portion is pressed.

4. The input device according to claim 3, wherein the coordinate input member has a detection sheet detecting a position where the conductive indicator has been moved closer on the basis of variation in capacitance and a reinforcement plate overlapping with the detection sheet, and a portion of the reinforcement plate is movable in the thickness direction at the movable portion.

5. The input device according to claim 3, wherein the coordinate input member has a detection sheet detecting a position where the conductive indicator has been moved closer on the basis of variation in capacitance, a portion of the detection sheet is flexible and deformable in the thickness direction at the movable portion, and the detection member is operated when a portion of the detection sheet is pressed.

6. The input device according to claim 3, wherein two movable portions are provided.

7. The input device according to claim 1, wherein the detection member is a press switch.

8. The input device according to claim 1, wherein the detection member is a piezoelectric element generating a voltage when the piezoelectric element is pressed, and the detection member reacts to the coordinate input member when the detection member is pressed by the coordinate input member.
